(19) United States
(12) Patent Application Publication
(10) Pub. No.: US 2006/0018016 A1
(43) Pub. Date: Jan. 26, 2006

(54) Device for viewing stereoscopic images on a display

(76) Inventors: Oleg K. Nikiforov, St. Petersburg (RU); Alexander V. Markovich, St. Petersburg (RU)

Correspondence Address: HOUSTON ELISEEVA, 4 MILITIA DRIVE, SUITE 4, LEXINGTON, MA, 02421, US

(21) Appl. No.: 11/186,232

(22) Filed: Jul. 21, 2005

(30) Foreign Application Priority Data
Jul. 22, 2004 (RU) 2004123516

(51) Int. Cl. G02B 27/22

(52) U.S. Cl. 359/462

(57) ABSTRACT

A device for viewing stereoscopic images, displayed by a video display as a stereopair of left and right images, is presented. It includes the left and right magnifying lenses, positioned between the eyes of the viewer and the display screen, the left and right mirrors with their respective reflective surfaces facing each other, and a main frame. The lenses are positioned between the eyes and the pairs of mirrors; the left and right mirror pairs are positioned perpendicularly and symmetrically in relation to the plane of the lenses' optical axes, and in mirroring symmetry in relation to the lenses' vertical symmetry plane, orthogonally to the said plane. The mirrors in each pair are so positioned and oriented at such an angle that the video-displayed left and right stereopair images are projected onto the left mirrors of the left pair and the right mirrors of the right pair, respectively and from them reflected onto the right mirrors of the right pair and the left mirrors of the left pair.

### RELATED APPLICATIONS

The application claims priority to Russian patent application Number 2004123516, filed in the Russian Patent Office on Jul. 22, 2004, which priority application is incorporated herein by reference.p

### BACKGROUND OF THE INVENTION

The present invention relates to the field of personal devices for viewing stereoscopic images. In particular, the device serves to view static as well as dynamic stereoscopic images, video-displayed as two simultaneously reflected, spatially separated images that form a stereopair.

The simplest personal-use devices for viewing static stereoscopic images presented as spatially separated stereopairs are stereoscopes—devices for viewing static stereoscopic images presented as a stereopair of left and right photo shots on a transparent film, photograph, or imprint. (application for patent in France: FR 2732778A1, MPK6 G 02 B 27/22, published Nov. 10, 1996; U.S. Pat. No. 5,499,136 issued Mar. 12, 1996, MPK6 G 02 B 27/22; U.S. Pat. No. 6,456,433 issued Sep. 24, 2002, MPK7 G 02 B 27/22; U.S. Pat. No. 6,487,013 issued Nov. 26, 2002, MPK7 G 02 B 27/22; U.S. Pat. No. 5,384,655 issued Jan. 24, 1995, MPK6 G 02 B 27/24). Photo images of the stereopair need to be obtained from two points and to overlap, so as to provide presentation of objects as they are viewed by the observer's left and right eyes. All stereoscopes are built to provide for such beam deflection from the common points on the objects' reflections that these objects are perceived as superimposed when the beams are directed at the observer's eyes. In some instances, specially constructed reflective mirrors are used for this (FR 2732778A1), in others—lenses (U.S. Pat.Nos. 5,499,136 and 6,456,433), yet in others—prisms (U.S. Pat. No. 6,487,013). In the application for French patent 2732778 (a folding stereoscope for viewing stereopair images in printed matter), two pairs of mirrors with facing each other's reflective surfaces are used; they are positioned between the left and right stereopair images as well as left and right eye slots behind which the viewer's eyes are located during the viewing. The mirror pairs and eye slots are disposed on a portable main frame.

Common elements of all versions of the present invention are the two pairs of mirrors with their reflective surfaces facing each other, which are mounted onto a main frame and are positioned before both stereopair images during the viewing of stereo images, thus enabling direct beaming into the viewer's eyes.

U.S. Pat. No. 5,499,136 (stereographic book) stipulates that the collapsible (or folding) stereoscope comprises left and right lenses to be placed before the viewer's eyes; positioned behind the lenses is a set of stereopair images implemented as left-hand and right-hand images centered along the lenses' optical axes. Stereopair images on the bottom part are attached like pages in a book, which allows view a significant number of images by flipping through the pages.

Another stereographic book (U.S. Pat. No. 6,456,433) is also a stereoscope with right and left lenses mounted onto a main frame to be adjusted to the distance between the centers of the viewer's eyes. Left and right stereopair images are disposed perpendicularly to the lenses' optical axes. The stereoscope permits the viewing of a series of stereopair images printed on a page one after the next by way of moving the pages between the lenses.

A common element of the stereoscopes in U.S. Pat. No. 5,499,136 and No. 6,456,433 and the present invention in all its versions is the use of the lenses positioned in front of the viewer's eyes.

The use of lenses provides for the enlarged imaginary stereo images. Unlike real-life 3-D images, he viewer perceives these stereo images to be in close proximity to him or her, which increases the observation angle of the stereo images and enhances the effect of the viewer's presence in the observed setting.

One area of use of the said stereoscopes is the viewing of small-size stereopairs, allowing the viewer to accumulate a collection of such images that would fill a small volume. One common disadvantage is that they are unfit for viewing imaginary stereoscopic images on large-screen TV and computer monitors with high resolution and a large observation angle.

Advancements in the field of television and computer technology have opened new possibilities for the acquisition and viewing of video-displayed static, as well as dynamic stereoscopic images.

Stereoscopic display systems, in which stereopair images, consecutively reflected on the entire screen, pass through commutated polarizers, have been known. The polarizers consecutively rotate the plane of polarization of an image of one stereopair at a 90° angle relative to the image of the other stereopair. The viewer uses polarizing goggles, having the plane of polarization for each of the eyes corresponds to the plane of polarization of the image directed at each eye (U.S. Pat. No. 4,772,943 issued Sep. 20, 1988, MPK4 H 04 N 13/00; No. 4,870,486 issued Sep. 26, 1989, MPK4 H 04 N 13/00; No. 4,877,307 issued Oct. 31, 1989, MPK4 G 02 B 27/26, H 04 N 13/00; No. 5,933,127 issued Aug. 3, 1999, MPK6 G 09 G 3/36). Also widely used are stereoscopic systems with shuttered goggles, in which consecutively reflected video-displayed images for the left and right eyes are synchronized with the function of the fast-acting, liquid crystal shutters, allowing only designated stereopair images to impinge onto the eyes (patent application RF No. 94031134, published Jun. 10, 1996, MPK6 H 04 N 13/00; U.S. Pat. No. 5,757,546 issued May 26, 1998, MPK6 G 02 B 27/22, H 04 N 9/47; H 04 N 13/00; U.S. Pat. No. 6,456,432 issued Sep. 24, 2002, MPK7 G 02 B 27/26, H 04 N 15/00, H 04 N 13/04).

The stereoscopic video-display systems listed above provide for an individual, as well as collective viewing of stereo images (with each viewer's personal polarizing or liquid-crystal shuttered goggles). However, one of the disadvantages of such systems is in how easily the viewers get tired of the switching resulting from the consecutive transmission of the stereopair images.

Among personal-use devices for viewing static and dynamic stereoscopic images video-displayed as two simultaneously reflected, spaced apart images forming a stereopair, devices to be worn as helmets have been known. Mounted in the helmet are two separate displays showing the stereopairs for the left and right eye, respectively. The displays are either located right in front of each eye, or the images are directed straight to the eyes through magnifying lenses and/or mirrors (U.S. Pat. No. 4,310,849 as of Jan. 12, 1982; U.S. Pat. No. 5,034,809 issued Jul. 23, 1991; U.S. Pat. No. 5,106,179 issued Apr. 21, 1992; U.S. Pat. No. 5,129,716 issued Jul. 14, 1992; U.S. Pat. No. 5,276,471 issued Jan. 4 [symbol] , 1994; U.S. Pat. No. 5,347,400 issued Sep. 13, 1994; U.S. Pat. No. 5,825,340 issued Oct. 20, 1998; U.S. Pat. No. 5,880,773 issued Mar. 9, 1999. In the enumerated patents, the display means, i.e. two separate displays, presents the stereoscopic image as simultaneously shown spaced apart right and left images forming a stereopair.

Also known is a stereoscopic television system (U.S. Pat. No. 4,523,226 issued Jun. 11, 1985), in which the stereoscopic image is presented on the video-display screen as simultaneously shown, spaced apart upper and lower images that form a stereopair. To achieve the viewer's perception of the stereo image with a height-to-width proportion equal to that of the screen (usually 3:4), the upper and lower stereopair images are vertically compressed by a factor of two. For a separate perception of the lower and upper image by the viewer's eyes, the polarizers with mutually orthogonal polarization axes are used and positioned on the upper and lower screen fields and before the viewer's eyes. Normal proportions of the compressed images are achieved through the use of prisms (FIGS. 12A, 12B and corresponding description in the specification of that patent.) However, the use of polarizers results in strong absorption of light emitted by the screen, and the distortion of color rendition, while the prisms distort the image due to dispersion of light.

The closest in utility and distinguishing elements to the present invention in all of its versions is the personal video-viewing device described in the mentioned U.S. Pat. No. 5,034,809 (FIG. 7(b)-10 and corresponding description in the specification of that patent.) It will be referred to as the prototype. This mechanism has a display in the form of two liquid crystal screens for rendering an image. Each screen is viewed with the left and right eyes, respectively. The display also contains a pair of magnifying lenses for the left and right eyes, respectively, and a main frame to mount the screens and lenses on the head, so that the left and right imaginary reflections formed by the magnifying lenses get superimposed when images are viewed on the screens by the left and right eye, thus enabling stereoscopic viewing.

In the apparatus proposed in the above-referenced U.S. patent in FIGS. 7(b)-10, the screens are positioned above the viewer's eyes, and on both sides of each lens there are pairs of mirrors having their respective reflective surfaces facing each other. The respective reflective surfaces direct the stereopairs' optic axes from the displays toward the viewer's eyes. The lower mirrors in each pair are semi-transparent, and thus allow the viewer to observe his/her surroundings and see through the images while walking.

A common element in the prototype and the first embodiment of the present invention is its intended use, as both are the devices for viewing stereoscopic images video-displayed as a left and right image stereopair; both comprise a left and a right magnifying lens positioned between the viewer's eyes and the display, a left and right pair of mirrors with their respective reflective surfaces facing each other, and a main frame.

A common element in the prototype and the second and third embodiments of the present invention is its intended use: all thee are the devices for viewing stereoscopic images video-displayed as a stereopair of images, one of which should be viewed with the right eye, the other with the left eye; all three comprise a left and a right magnifying lens positioned between the viewer's eyes and the display, a left and right pair of mirrors with respective reflective surfaces facing each other, and a main frame.

However, the prototype is capable of providing the viewing of stereo images presented as two simultaneously shown, spaced apart images that form a stereopair, on computer monitor and TV screens.

### SUMMARY OF THE INVENTION

The prototype's disadvantages are the following: low image definition caused by a small display size, small observation angle (30° on average) due to the limitations of the helmet's construction and the impossibility of maneuvering it, and viewer fatigability caused by the pressure exerted by the device, in particular on the nose, forehead, and cheeks.

The present invention and its embodiments solve the problem of providing a personalized device for viewing static and dynamic stereoscopic images, video-displayed on a large screen (television or computer monitor) as two simultaneously shown, spaced apart images that form a stereopair. The stereoscopic images have high definition, a large observation angle, and a possibility for the viewer to choose this angle. Another problem solved by the present invention is the implementation of the invention as a collapsible and/or easily portable attachment mounted on or in front of a video display screen, providing universal use of standard display means as the means for viewing stereoscopic images, as well as the means for viewing mono images. Furthermore, the present invention solves the problem of viewer fatigability caused by wearing the video viewing device on the head.

The first embodiment of the present invention provides viewing of stereoscopic images video-displayed as a stereopair of left- and right-hand images. In that embodiment the height-to-width ratio of the stereoscopic images is 3:2 when the dimensions of a fully used screen are a 3:4; the height-to-width ration is 9:8 when on the dimensions of the screen is 9:16. The second embodiment of the present invention provides viewing of stereoscopic images, video-displayed as a stereopair of left- and right-hand images. In that embodiment the height-to-width ratio of the stereoscopic images is 1.5:4 when the dimensions of a fully used screen are a 3:4; the height-to-width ration is 4.5:16 when on the dimensions of the screen is 9:16 The latter embodiment provides for the wide-format stereo images. In the third embodiment of the present invention the device is universal and provides for setting up of modules for viewing stereoscopic video-displayed images as a stereopair of the left and right images, as well as the upper and lower images, with height-to-width ratios specified for the first and second embodiment when the full screen is utilized.

The technical result achieved by the present invention and its embodiments is the following:

providing technical means for the individual viewing of static and dynamic stereoscopic images, video-displayed as two simultaneously shown, spaced apart images forming a stereopair on a large screen of standard computer monitors and televisions. At the same time, the first embodiment of the invention allows the viewing of stereo images shown as a stereopair of the left and right images; the second embodiment of the present invention allows the viewing of stereo images shown as a stereopair of the upper and lower images; the third embodiment provides viewing of both types of stereo images.

providing for the viewing of these stereo images in high definition. For example, a standard, 19″ liquid crystal computer display has a definition of 655,360 pixels for both the right and left stereopair image. The prototype device with a liquid crystal display of high definition has a definition of 123,200 pixels due to the small size of its display (1.5″), determined by the distance between the eyes' axises. High definition of an image allows to discern small details of the image and enhance the perception of reality of the observed setting.

providing for the viewing of stereoscopic images with wide viewing angles, which is achieved through the proximity of the large screen to the viewer's eyes and through the use of a system of lenses and mirrors to focus the eye on the projected image. In the present invention, the viewing angle is 45-60° when viewing a stereopair of right and left images, and 80-95° and more when viewing a stereopair of images one above the other. Meanwhile, in the prototype, the viewing angle averages 30° which creates an effect of virtual space and the viewer's presence in the observed setting.

providing for adjustment of the viewing angle of the stereoscopic image, as desired by the viewer, by varying the distance between the viewing device and the display screen. The prototype lacks such a feature due to the fixed distance between the displays and the viewer's eyes on the helmet.

solving the problem of viewer's fatigue caused by the positioning on the head of a viewing device, and the highly comfortable viewing of stereo images, since the use of large-diameter lenses eliminates the need to align the optical axes of the eyes with those of the lenses.

providing for universal use of the means of video display for viewing stereoscopic images as well as for their traditional use, due to the simple installation of the present invention in front of the display, as well as its easy removal.

The essence of the first embodiment of the present invention is defined by the following combination of its essential elements, which provides the technical result in all its variations:

The device for viewing stereoscopic images, displayed by a video display as a stereopair of left and right images. It includes the left and right magnifying lenses, positioned between the respective eyes of the viewer and the display screen, the left and right mirrors with their respective reflective surfaces facing each other, and a main frame. It differs from the prototype in that the lenses are positioned between the eyes and the paired mirrors; the left and right mirror pairs are positioned perpendicularly and symmetrically in relation to the plane of the lenses' optical axes, and in mirroring symmetry in relation to the lenses' vertical symmetry plane, orthogonally to the said plane. Meanwhile, the mirrors in each pair are so positioned and oriented at such an angle that the video-displayed left and right stereopair images are projected onto the left mirrors of the left pair and the right mirrors of the right pair, respectively and from them reflected onto the right mirrors of the right pair and the left mirrors of the left pair. Then the images are reflected through the left and right lenses onto the right and left eyes of the viewer: the left stereopair image is directed at the left eye, video-displayed on the screen and corresponding to the imaginary picture located at a virtual distance from the left eye, and the right stereopair image is directed at the right eye, video-displayed on the screen and corresponding to the imaginary picture located at a virtual distance from the right eye. When the left and right eyes arrive at a convergence angle corresponding to the angle defined by the said virtual distance of the image, the viewer is able to view stereoscopic images, video-displayed as a stereopair of left and right images.

In the particular case of the first embodiment, the present invention will differ from the prototype in that the main frame is executed as a box with parallel upper and lower panels in which the left and right mirror pairs are installed perpendicularly to those panels. The side of the box facing the viewer carries the magnifying lenses.

The other difference in this particular case is that the magnifying lenses are located on the side facing the viewer, enabling their adjustment to the distance between the centers of the viewer's eyes.

Another implementation of the first embodiment of the present invention is a device that differs from the prototype in that the magnifying lenses and corresponding mirror pairs are formed as identical optical modules with fixed mutual positioning of the lenses and mirrors. The left and right modules are mounted on the frame with one module turned to the other at a 180° angle about the axis of its magnifying lens.

In a particular case of the above implementation of the first embodiment of the present invention, the device will differ in that the modules will be placed on the main frame so as to allow horizontal adjustment to the distance between the centers of the viewer's eyes.

In the specific implementations of the first embodiment of the present invention, which are characterized both by the features common for all the implementations and by the specific features of all the implementations mentioned above, the device differs from the prototype in that the lenses' diameter equals 0.5 to 1.0 of the distance between the lenses' optical axes. In an alternative implementation, the diameter of the lenses can be set as greater than 1.0 but less than 1.3 of the distance between the lenses' optical axes; the lenses are built with equal severed segments at the boundary between the lenses.

In specific cases of the first embodiment of the invention, the difference from the prototype is that each mirror on the left and right pair is shaped as a trapezoid, its size providing for the viewer's perception of images with borders corresponding to each stereopair image, and eliminating images outside those borders.

An important implementation of the first embodiment of the invention is a device that is different in that it contains a yoke to attach it to the video display comprising an upper horizontal panel and side vertical panel with means of affixing it to the body of the video display. The main frame of the device is mounted on a rectangular framework attached to the yoke with joint panels equipped with latches and other fixing elements, providing for the positioning of the device in a way that the plane of the optical axes of the lenses passes through the center of the video display screen, providing for the distance between the device and the video display screen can be altered, and providing for the possibility to move the device into a position above the screen when not used.

A particular case of this last implementation is a device distinct in that the upper horizontal beam of the attachment mechanism and the rectangular framework are expandable, so as to adjust to the size of the video display.

An alternative way to secure the present invention in its first embodiment in front of the video display screen is a device equipped with a unit that includes a base to be positioned on the desk in front of the display; located on the corners of the base are bushings with inserted bearing rods to adjust the distance to the screen; the rods, in turn, support the main frame of the device, thus enabling vertical adjustment.

The essence of the second embodiment of the present invention is defined by the following combination of its essential elements, which provides the technical result in all its variations:

The device is for viewing stereoscopic images video-displayed as a stereopair of images, one of which should be viewed with the left eye, the other with the right, and containing left and right side magnifying lenses, left and right side pairs of mirrors with their respective reflective surfaces facing each other, and a main frame, to be positioned between the viewer's eyes and the display screen. It differs from the prototype in that to view the stereopair with images positioned one above the other, the lenses are positioned between the eyes and the mirror pairs, in such a way that the positioning and angle of one pair of mirrors are adjusted to direct the optical axes of the upper stereopair image through a corresponding lens to one eye, while the positioning and angle of the other pair of mirrors are similarly adjusted to direct the optical axes of the lower stereopair image through a corresponding lens and to the viewer's other eye. Directed into one eye is the upper stereopair image video-displayed and corresponding to the imaginary picture located at a virtual distance from the eye; directed into the other eye is the lower stereopair image video-displayed and corresponding to the imaginary picture located at a virtual distance from that eye. When the eyes reach a convergence angle corresponding to the virtual distance of the image, the viewer achieves stereoscopic vision of the image video-displayed as a stereopair of upper and lower images.

In the particular implementation of the second embodiment, the invention will differ from the prototype in that the optical axes going from the upper and lower stereopair images through the corresponding mirror pairs and lenses lie in vertical planes, and the mirror pairs are positioned perpendicularly to the said vertical planes at angles that allow for the direction of the optical axes of the upper and lower stereopair images to the left and right eye of the viewer, respectively.

In a specific implementation of the second embodiment, the invention will differ from the prototype in that the magnifying lenses and corresponding mirror pairs are executed as identical optical modules and mounted on the frame so that one module is at a 180° angle to the other about the axis of its magnifying lens and the modules face in opposite directions at a 90° angle to the lenses' optical axes plane.

One particular case of the implementation of this device with identical optical modules is a device that differs from the prototype in that the modules will be linked by a cylindrical joint mounted into the main frame with the possibility of changing the angle between the vertical planes of the modules' optical axes.

One specific implementation of the second embodiment is a device distinct in that the lenses have a diameter equaling 0.5 to 1.0 of the distance between the lenses' optical axes. In an alternative implementation, the diameter can be set as greater than 1.0 but smaller than 1.3 of the distance between the lenses' optical axes, and the lenses are built with equal severed segments at the boundary between the lenses.

Another specific implementation of the second embodiment is a mechanism that differs in that each mirror of the left and right pair is shaped as a trapezoid of a size that ensures the viewer's perception of images with borders corresponding to each stereopair image and eliminating perception of images outside these borders.

An important implementation of the second embodiment of the invention is a device distinct in that it is equipped with a yoke to attach it to the video display (similarly to the first embodiment). The yoke consists of an upper horizontal panel and side vertical panels with means to affix it to the video display. The main frame is mounted onto a rectangular framework that is attached to the mechanism with joint panels equipped with latches and other fixing elements, providing for the positioning of the device in a way that the plane of the optical axes passes through the center of the video display screen, the distance between the device and the video display screen can be altered, and the device can be moved into a position above the screen when not used.

A particular case of this last implementation is a mechanism distinct in that the upper horizontal beam of the attachment mechanism and the rectangular framework are expandable, so as to adjust to the size of the video display.

An alternative way to secure the present invention in all implementations of the second embodiment (same as when it is in the first embodiment) in front of the video display screen is a distinctive mechanism equipped with a unit that includes a base to be positioned on the desk in front of the display; located on the corners of the base are bushings with inserted bearing rods to adjust the distance to the screen; the rods, in turn, support the main frame of the device, thus enabling vertical adjustment.

The essence of the third embodiment of the present invention is defined by the following combination of its essential elements, which provides the technical result in all its variations:

The device is for viewing stereoscopic images video-displayed as a stereopair of images, one of which should be viewed with the left eye, the other with the right, and containing left and right magnifying lenses, left and right pairs of mirrors with their respective reflective surfaces facing each other, and a main frame, to be positioned between the viewer's eyes and the display screen. It differs from the prototype in that the lenses are positioned between the eyes and mirror pairs, and the mirror pairs are two identical optical modules, which can be placed in different positions on the frame, so that upon viewing stereoscopic images video-displayed as left and right stereopair images or upper and lower stereopair images, the optical axes stemming from the left and right stereopair images or upper and lower stereopair images, respectively, are directed into the left and right eye of the viewer.

In the particular implementation of the first embodiment, the invention it will differ from the prototype in that on the side facing the viewer, the optical modules carry a square binding frame with molded edges, while the main frame is rectangular, with directing slots corresponding to the molded edges, so as to position the optical modules as a distance corresponding to the centers of the viewer's eyes, in a position that would enable viewing of stereoscopic images video-displayed as a left- and right-hand stereopair, or upper and lower stereopair.

An alternative specific implementation of the third embodiment, the invention differs from the prototype in that the optical modules will have, along the side facing the viewer, a circular fast attached to another circular fast molded onto the main frame, the former capable of rotating about the optical plane of the magnifying lens, the latter a correspondingly molded rod. Rotation will ensure the positioning of modules in a way that the their optical axes lie in the plane of the eyes' optical axes for the viewing of stereoscopic images video-displayed as a left and right stereopair images, or in a position where the modules' axes lie in planes perpendicular to the eyes' optical axes and on different sides thereof, for the viewing of stereoscopic images video-displayed as upper and lower stereopair images.

In one specific implementation of the third embodiment, the invention is a device distinct in that the optical modules consist of a hollow frame containing the mirror pairs, and an end flange facing the viewer, which will support the lens and remain attached to the hollow frame with tuning screws; there are also springs on the screws between the flange and frame.

Another distinguishing feature of the abovementioned devices executed the third embodiment is that the lenses' diameter equals 0.5 to 1.0 of the distance between the lenses' optical axes. Alternatively, the diameter can be set as greater than 1.0 but smaller than 1.3 of the distance between the lenses' optical axes, with the lenses built with equal severed segments at the boundary between the lenses.

Another implementation of the third embodiment is a device distinct in that, like Versions 1 and 2, it is equipped with a yoke to attach it to the video display (similarly with the first and second embodiments). The yoke consists of upper horizontal panels and side vertical panels with means to affix it to the video display. The main frame is mounted onto a rectangular framework that is attached to the yoke with joint panels equipped with latches and other fixing elements, providing for the positioning of the device in a way that the plane of the optical axes passes through the center of the video display screen, the distance between the device and the video display screen can be altered, and the device can be moved into a position above the screen when not used.

One specific case of this last implementation is a device distinct in that the upper horizontal beam of the attachment mechanism and the rectangular framework are expandable, so as to adjust to the size of the video display.

An alternative way to secure the proposed invention in its third embodiment (same as the first and second embodiments) in front of the video display screen is a device equipped with a contraption that includes a base to be positioned on the desk in front of the display; located at the corners of the base are bushings with inserted bearing rods to adjust the distance to the screen; the rods, in turn, support the main frame of the device, thus enabling vertical adjustment.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

The essence of the invention is depicted on the drawings, as follows.

FIG. 1 is a schematic diagram that demonstrates the principle of constructing the device for viewing stereoscopic images video-displayed as left and right stereopair images, in accordance with the first and second embodiments of the present invention.

FIG. 2 demonstrates a particular implementation of the first embodiment, in which the main frame is executed as a box.

FIG. 3 shows further development of the invention as shown in FIG. 2, in which the lenses are positioned to enable adjustment to the distance between the centers of the viewer's eyes.

FIG. 4 shows another implementation of the first embodiment. In it, the magnifying lenses and corresponding mirror pairs are executed as identical optical modules.

FIG. 5 shows a particular case of as the implementation shown in FIG. 4, in which the modules are positioned on the main frame to enable adjustment to the distance between the centers of the viewer's eyes.

FIGS. 6a and 6b depict the geometry of the optical lenses and their positioning relative to the viewer's eyes, which applies to all embodiments of the invention.

FIG. 7 shows a particular case of the first embodiment, in which the mirrors are shaped as trapezoids.

FIG. 8 shows the details of the unit that can be used for the attachment of the invention in all embodiments to the video display screen.

FIG. 9 shows another unit that can be used for the attachment of the invention in all embodiments to the video display screen.

FIG. 10 is a schematic diagram that demonstrates the principle of the second embodiment of the invention, with the stereo image video-displayed as a pair of upper and lower stereopair images.

FIG. 11 is a diagram of an important specific case of FIG. 10, in which the optical axes originating at the upper and lower stereopair images and passing through the corresponding mirror pairs, lie in vertical planes.

FIG. 12 depicts a specific implementation of the third embodiment of the invention, in which the magnifying lenses and corresponding mirror pairs are executed as identical optical modules.

FIG. 13 shows a particular case where the device is executed according to FIG. 12 with identical optical modules, hinged together so as to enable adjustment of the angle between the vertical planes of the optical axes.

FIGS. 14a and 14b are schematic diagrams, demonstrating the principle of constructing and implementing the third embodiment of the invention. The stereo image is displayed as left and right or upper and lower stereopair images. The lenses and mirrors are made as identical optical modules.

FIG. 15 shows a particular case of executing the invention according to FIG. 14, in which the modules are attached to the main frame with molded edges and directing slots to enable the positioning of the modules for viewing stereo images as left and right stereopair images (see FIG. 15a) or upper and lower stereopair images (see FIG. 15b).

FIG. 16 shows another particular case of executing the invention as indicated in FIG. 14. The modules are secured on the main frame executed as a molded rod with circular fasts so as to enable rotation and positioning, making possible the viewing of stereoscopic images as left and right (see FIG. 16a) or upper and lower (see FIG. 16b) stereopair images.

FIG. 17 demonstrates the construction of modules for the third embodiment of the invention, which allows for angular adjustment of the lens's optical axis.

### DETAILED DESCRIPTION OF THE PREFERRED EMBODIMENTS

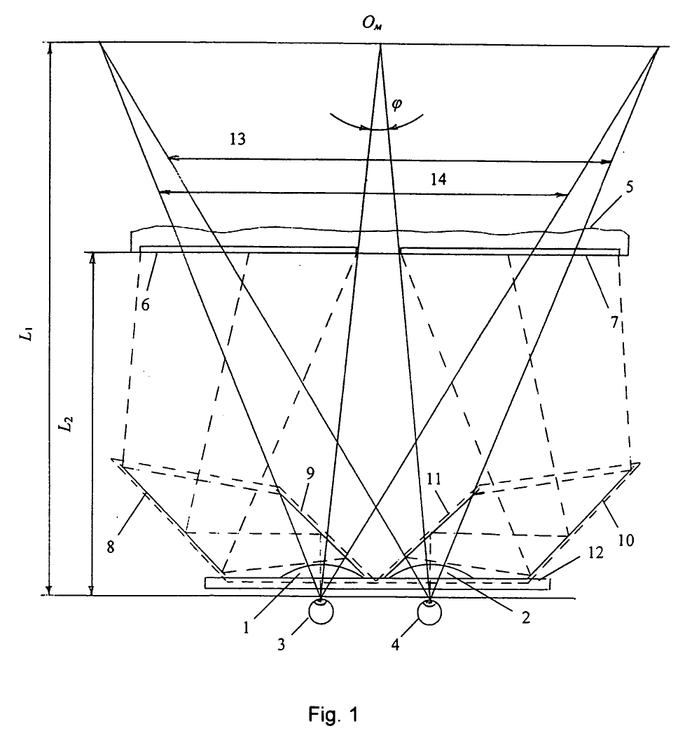

In the first embodiment of the present invention, the viewing devices are intended for viewing stereoscopic images video-displayed as simultaneously reflected, spatially separated left and right images that form a stereopair. All implementations of the first embodiment contain (see FIG. 1): left (1) and right (2) magnifying lenses, positioned between the left (3) and right (4) eyes of the viewer and the screen (5), displaying the stereoscopic image as a stereopair of left (6) and right (7) images; left (8,9) and right (10, 11) mirror pairs with their respective reflective surfaces facing each other; and a main frame (12, roughly sketched.) The lenses (1, 2) are positioned between the eyes (3, 4) and the mirror pairs (8,9 and 10,11). The left (8,9) and right (10,11) mirror pairs are installed perpendicularly and symmetrically in relation to the lenses' optical axis plane, and in mirroring symmetry to the lenses' vertical symmetry plane, orthogonal to the lenses' optical axis plane. The mirrors of each pair are angled so that the left (6) and right (7) stereopair images displayed on the video display (5) are projected correspondingly on to the left mirror (8) of the left pair and the right mirror (10) of the right pair. They are then correspondingly reflected onto the right mirror (9) of the left pair and the left mirror (11) of the right pair. Then, in turn, they are reflected through the corresponding left (1) and right (2) lens to the left (3) and right (4) eye of the viewer. The device's functions so that, when positioned in front of the video display screen reflecting stereoscopic images as left and right stereopairs, and given the execution of the device in accordance with the above description, the left eye (3) receives the left (6) stereopair image, video-displayed (5) and corresponding to the imaginary picture (13) located at a virtual distance L₁ from the left eye. Similarly, the right eye (4) receives the right (7) stereopair image, corresponding to the imaginary picture (14) located at a virtual distance L₁ from the right eye. As a result, when the left (3) and right (4) eye arrive at a convergence angle φ, which corresponds to the angle determined by the mentioned virtual distance L₁, the viewer is able to view stereoscopic images video-displayed (5) as a stereopair of left (6) and right (7) stereopair images, located at a distance L₂ from the viewer's eyes.

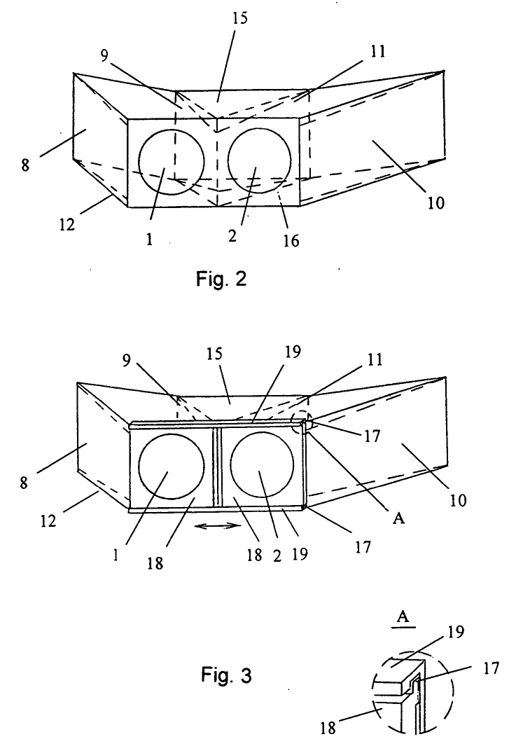

In one important implementation of the first embodiment, the invention will contain (see FIG. 2) a main frame, (12) shaped as a box with parallel upper (15) and lower (16) panels, in which left (8,9) and right (10,11) mirror pairs are installed perpendicularly to these panels; the side facing the viewer supports the magnifying lenses (1,2). Further development of this implementation is a device (see FIG. 3), which allows adjustment of the magnifying lenses (1, 2) to the distance between the centers of the viewer's eyes. This utility demonstrated by the device in FIG. 3 is provided by the molded edges (17) of the lens (1, 2) holders (18), which allow them to move in the grooves or the guiding laths (19). A minor change in the lenses' position relative to the mirror pairs (8, 9, and 10, 11) during the adjustment of the lenses to the distance between the centers of the eyes will not compromise the quality and comfort of the stereo image viewing experience. Executing the device in accordance with FIGS. 2 and 3, with the main frame shaped as a box, will ensure high manufacturability and easy assembly of devices for viewing stereo images made in accordance with the first embodiment of the invention.

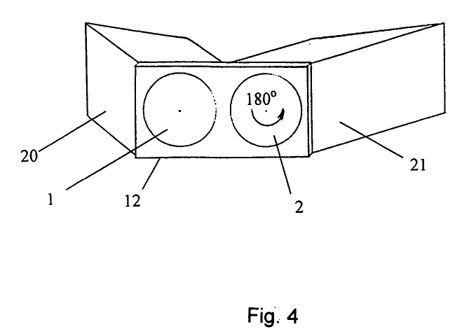

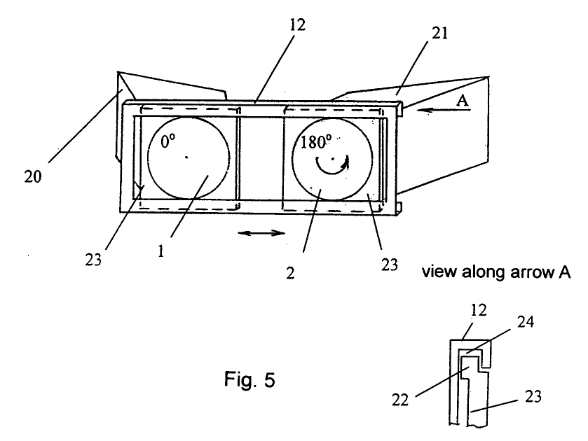

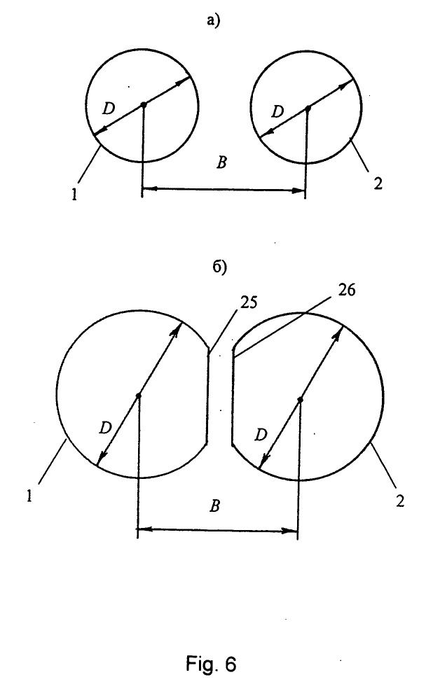

Another implementation of the first embodiment is a device (see FIG. 4), in which the magnifying lenses (1,2) and corresponding mirror pairs (8,9 and 10,11 in FIG. 1) are two identical optical modules (20 and 21) with fixed mutual positioning of lenses and mirrors. To ensure the mirror symmetry of the mirror pairs relative to the vertical symmetry plane of the lenses (1,2), orthogonal to their optical axes' plane, the modules (20, 21) will be mounted onto the main frame (12) with one module (21) turned to the other (20) at a 180° angle about the axis of its magnifying lens (2). In the particular case of this implementation (see FIG. 5), the modules (20, 21) are positioned on the main frame (12) to ensure horizontal adjustment to the distance between the centers of the viewer's eyes, which in this case can be achieved by way of the ribbed (22) flanges (23) on the module side facing the viewer, and the reference slots (24) on the main frame (12).

The following description holds for the specific implementations of the first embodiment of the invention, which are characterized both by the features common for all implementations and the alternative features of all specific implementations described above: the left (1) and right (2) magnifying lenses; diameter, D, will equal 0.5 to 1.0 of the distance B between the lenses' optical axes (see FIG. 6a). The distance B is set at the average distance between the centers of the viewer's eyes, which equals 65 mm. Alternatively, the lenses' diameter D can be set as more than 1.0 but less than 1.3 of the distance B between the lenses' optical axes. The lenses are built with equal severed segments at the boundary between the lenses (see FIG. 6b). Large-diameter lenses, and in particular large lenses with severed segments, allow the viewer to view the stereoscopic image without the eye fixating on the lenses' optical axes, thus preventing viewer fatigue.

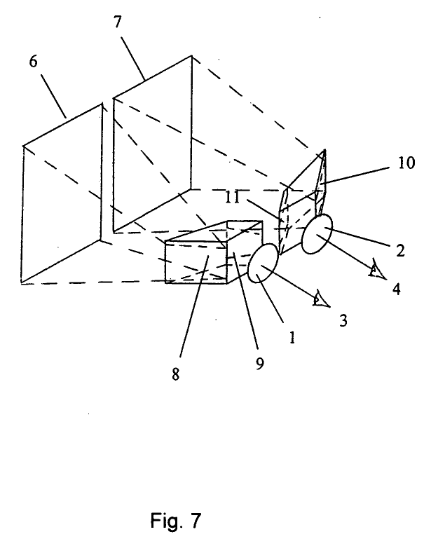

In the particular implementation of the first embodiment of the invention and in any of its specific forms, each mirror of the left (8, 9) and right (10,11) pair (see FIG. 7) is shaped as a trapezoid of a size ensuring the viewer's perception of the images as with borders corresponding to the left (6) and right (7) stereopair images, and eliminating images outside those borders. This shape and size replicates the borders of the projections made by the left (6) and right (7) stereopair image on the left and right mirror pairs; the form and shape of the mirrors 8 and 9 match correspondingly to the form and shape of the mirrors 10 and 11. Given that the size of said projections grows as the device is moved closer to the video display screen within the distance range L₂, the size and shape of the mirrors are determined from the working range of the minimal distance L₂ when selecting the desired observation angle of the imaginary projections (13, 14) (see FIG. 1). The mirror's trapezoidal shape can be set either by cutting the mirrors of a determined shape and size, or by applying an optical mask onto a mirror. Shaping the mirrors thus will allow for viewing only of the information that is necessary for stereo image perception, at the exclusion of uncomfortable, extraneous information.

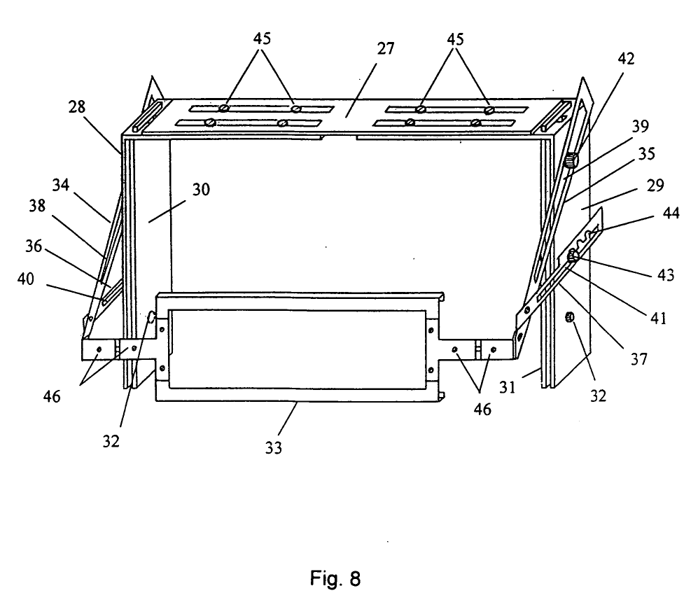

An important implementation of the first embodiment of the invention, which is also relevant to the second and third embodiments and applicable to all implementations, is a device equipped with a yoke (see FIG. 8) to affix it to the video display screen. The hard yoke, consists of upper and lower horizontal panels (27) and side vertical panels (28, 29). To affix it on the display screen's frame (5) (see FIG. 1), it also has moveable panels (30, 21) and jack screws (32). The main frame (12) (see FIG. 1) of the stereoscopic viewing device is mounted on a rectangular framework (33) (see FIG. 8), connected to the yoke with joint panels (34, 35, 36, 37). These panels have grooves (38,39,40,41) and fixing elements, which provides for the positioning of device in a way that the lenses' optical axis plane goes through the center of the video display screen, for the adjustment of the distance between the device and the screen, and for transferring the device above the screen when not used. The fixing elements depicted in FIG. 8 are retainer screws (42, 43). Other than that, the panels (36, 37) may contain ridged (44) grooves (40, 41) for rapid installment of the device at a preferred fixed distance from the display screen. In the specific case of affixing the device to the video display screen, the upper horizontal panel (27) of the yoke, as well as the rectangular framework (33), are made to be expandable to adjust to the size of the video display screen. For that purpose, they are made as elements to be assembled with grooves and retainer screws (45, 46).

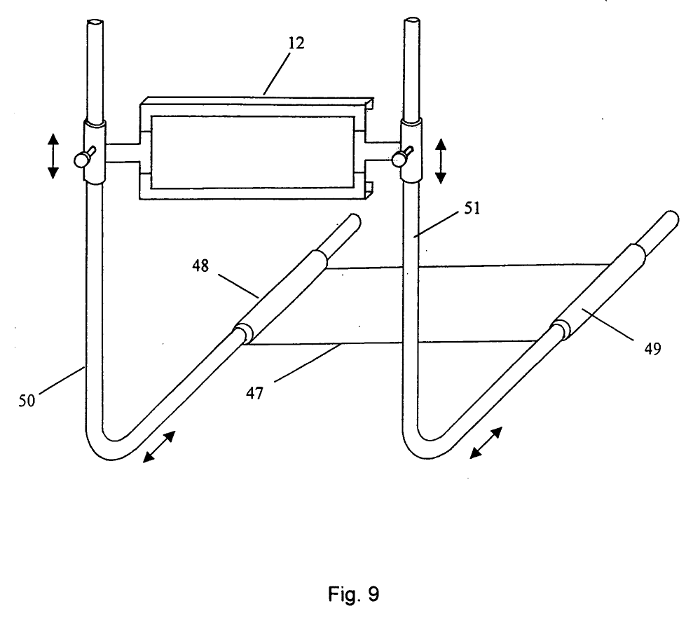

An alternative way to install the present invention before the video display screen in all implementations of its first embodinemt (as well as the second and third embodiments), is a device equipped with a mechanism (see FIG. 9) consisting of a base (47) to be positioned on the desk under the display screen, with side bushings (48, 49) to support bearing rods (50, 51) which in turn support the main frame (12) and enable vertical adjustment.

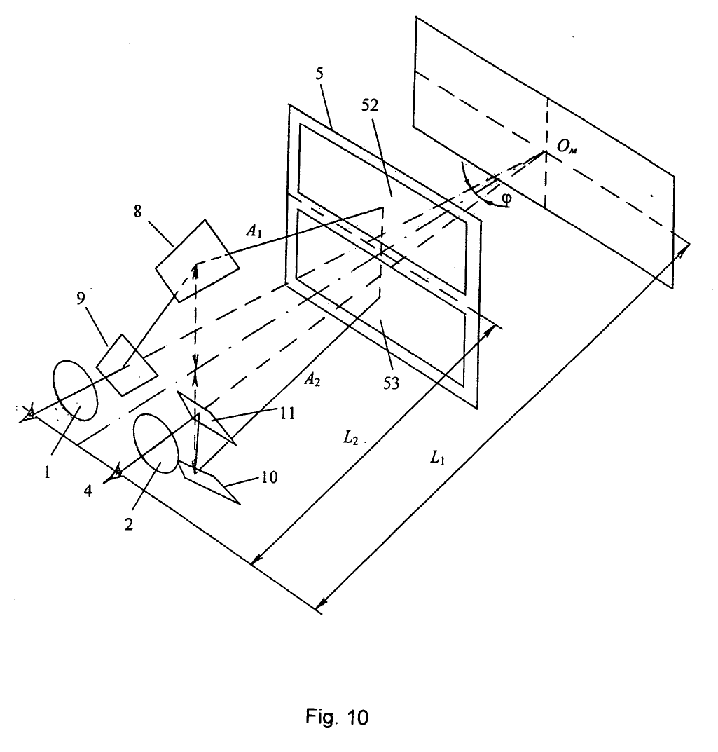

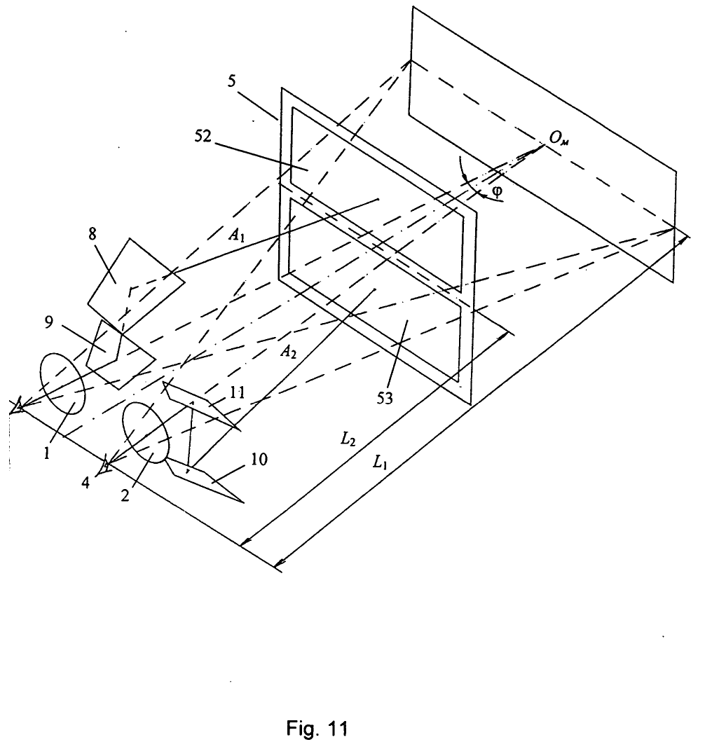

The stereoscopic viewing devices made according to the second embodiment of the invention is for viewing stereoscopic images video-displayed as simultaneously reflected, spatially separated upper and lower images that form a stereopair. In all its implementations, the second embodiment of the invention consists of (see FIG. 10): left (1) and right (2) magnifying lenses, positioned between the left (3) and right (4) eyes of the viewer, respectively, and the screen (5), displaying the stereoscopic image as a stereopair of upper (52) and lower (53) images; left (8, 9) and right (10, 11) mirror pairs with their respective reflective surfaces facing each other; and a main frame (not shown in FIG. 10.) The lenses (1, 2) are positioned between the eyes (3, 4) and the mirror pairs (8, 9 and 10, 11). The position and angle of one pair (In FIG. 10, the left pair 8,9) are selected so that the optical axis of the upper stereopair image (52) goes through the corresponding lens and into one eye (in FIG. 10, the left lens 1 and left eye 3); the position and angle of the other pair (in FIG. 10, the right pair 10, 11) are similarly selected so that the optical axis of the lower stereopair image (53) goes through the corresponding lens and into the other eye (in FIG. 10, the right lens 2 and right eye 4). The device functions in such a way that, when positioned in front of the video display screen reflecting stereoscopic images as upper and lower stereopairs, and given the execution of the device in accordance with the abovementioned description, the left eye (3) receives the upper (52) stereopair image, video-displayed (5) and corresponding to the imaginary picture located at a virtual distance L₁ from the left eye. Similarly, the right eye (4) receives the lower (53) stereopair image, corresponding to the imaginary picture located at a virtual distance L₁ from the right eye. As a result, when the left (3) and right (4) eye arrive at a convergence angle φ, corresponding to the angle at which the center of the imaginary picture O_{M} can be viewed and which is determined by the mentioned virtual distance L₁, the viewer is able to view stereoscopic images video-displayed (5) as a stereopair of upper (52) and lower (53) stereopair images, located at a distance L₂ from the viewer's eyes.

In the implementation of the second embodiment of the invention shown in FIG. 10, the left (8, 9) and right (10, 11) mirror pairs are positioned so that the optical axes A₁ and A₂ of the upper and lower stereopair images directed from the video display screen to the mirrors 8,10 lie in a plane that is a vertical symmetry plane of the imaginary picture lying at a virtual distance L₁. The axes pass through the geometrical centers of the upper (47) and lower (48) video-displayed (5) stereopair images. This case ensures the highest quality of perceived stereoimage viewing, because in the viewer's perception, not only are the centers superimposed, but so are the borders of the stereopair images.

In the general case of the second embodiment of the invention, the optical axes directed from the eyes through the lens and mirror pairs to the upper and lower stereopair images, may lie outside the vertical symmetry plane of the imaginary picture in the regions between the outside mirrors and stereopair images (in FIG. 10, A1, A2). However, a minor displacement of these optical axes regions from the vertical symmetry plane of the imaginary picture will not lead to a noticeably decreased stereo image quality.

In the important implementation of the invention (see FIG. 11,) the optical axes running from the upper (52) and lower (53) stereo pair images through the left (8,9) and right (10,11) mirror pairs and lenses (1,2) are in the vertical planes. The mirror pairs (8,9) and (10,11) are set perpendicular to the mentioned vertical planes at angles ensuring the direction of the optical axes of the upper (52) and lower (53) stereopair images to the left (3) and right (4) eye, respectively. In this case, the vertical planes running from the upper and lower stereopair images through the mirror and lens pairs to the eyes can be set as parallel so as to simplify the construction of the device. The resulting displacement B/2 of the optical axes of the upper (52) and lower (53) stereo image from the images' geometric centers and equaling in this case half of the distance between the centers of the viewer's eyes will not lead to a significant reduction in stereo image viewing quality.

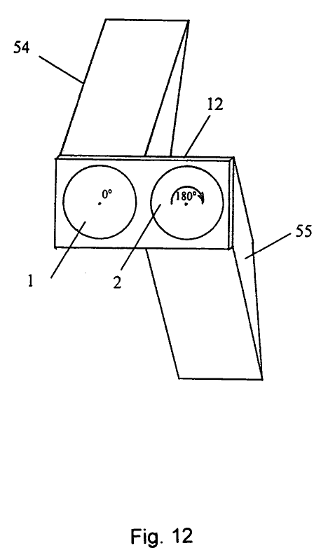

In a specific implementation of the second embodiment of the invention (see FIG. 12), the magnifying lenses (1, 2) and corresponding mirror pairs are two identical optical modules (54 and 55) which are mounted onto the main frame (12) with one module turned to the other at a 180° angle about the axis of its magnifying lens (in FIG. 12, module 55 is turned to module 54 at a 180° angle about the axis of its magnifying lens 2). Modular construction of the device is realized most simply by combining the vertical and parallel positions of the planes in which lie the optical axes passing from the upper and lower stereopair images through the mirror and lens pairs and to the eyes, even though it results in the displacement B/2 of the optical axes of the upper (52) and lower (53) images from the geometrical centers of these images.

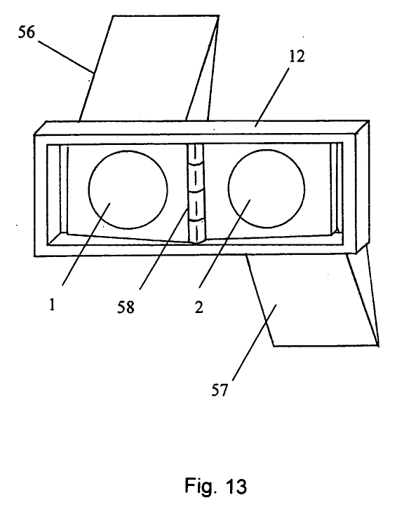

This drawback can be eliminated in another specific implementation of the second embodiment of the invention, with vertical positioning of the planes in which lie the optical axes passing from the upper and lower stereopair images through the mirror and lens pairs to the eyes, and with the optical system executed as identical optical modules (see FIG. 13). To provide for the adjustment of the angle between the vertical planes of the modules' optical axes, the modules (56, 57) will be joined by a cylindrical hinge (58) and mounted into the main frame (12). The hinge will allow the viewer to direct the optical axes stemming from the optical modules to the centers of the upper and lower images, and thus improve the quality of the viewed stereoscopic images.

The implementations of the second embodiment proposed in FIGS. 12 and 13 can be complemented with mechanisms to adjust horizontally the modules on the main frame and ensure the adjustment of the modules' optical axes to the distance between the centers of the viewer's eyes (similarly to the construction proposed in FIG. 5).

In the specific implementations of the second embodiment, similarly to the first embodiment, the left and right magnifying lenses' diameter, D, will equal 0.5 to 1.0 of the distance B between the lenses' optical axes (see FIG. 6a). The distance B is the average distance between the centers of the viewer's eyes (65 mm.) Alternatively, the lenses' diameter D can be set as more than 1.0 but less than 1.3 of the distance B between the lenses' optical axes, with the lenses are built with equal severed segments at the boundary between the lenses (see FIG. 6b). Large-diameter lenses, and in particular large lenses with severed segments, allow the viewer to view the stereoscopic image without the eye fixating on the lenses' optical axes, thus preventing viewer fatigue (similarly to the first embodiment of the invention).

In the particular implementations of the second embodiment, which are characterized both by the features common for all implementations and the alternative features of the implementations described above, each mirror of the left (8,9) and right (10,1 1) pair (see FIGS. 10, 11, as well as FIGS. 12, 13 where these mirrors are not shown) is shaped as a trapezoid of a size ensuring the viewer's perception of the images as with borders corresponding to each stereopair image, and eliminating the image parts outside these borders. This shape and size of the mirrors is chosen from the working range of L₂, the distance to the screen, and providing for the largest used screen size. Preparing the mirrors as described will exclude extraneous information during stereo image viewing, and thus prevent viewer's discomfort.

An important implementation of the second embodiment of the invention are the devices containing mechanisms for attachment to the video display screen or for positioning them in front of the display screen, as proposed for in the first embodiment (see FIGS. 8 and 9).

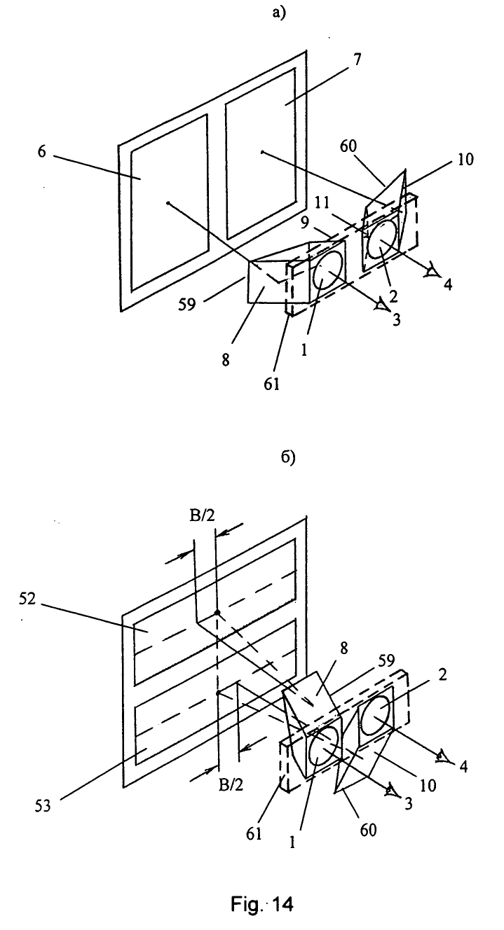

The third embodiment of the present invention is intended for viewing stereoscopic images video-displayed as simultaneously reflected, spatially separated upper and lower or right and left images that form a stereopair. In all its implementations, the third embodiment comprises (see FIG. 14) two identical optical modules (59,60) positioned on a main frame (61), providing for the selection of their position and angle so that the optical axes of the left (6) and right (7) video-displayed stereopair images (see FIG. 14a), or the upper (52) and lower (52) video-displayed stereopair images (see FIG. 14b) are directed into the left (3) and right (4) eyes of the viewer. The identical modules contain magnifying lenses (1,2) and pairs of mirrors (8,9 and 10,11) with their respective reflective surfaces facing each other; the lenses are located between the eyes and mirrors on the sides of the modules facing the viewer.

The simplest implementation of the identical optical modules for the device executed according to the third embodiment (as well as the first embodiment shown in FIGS. 4, 5 and the second embodiment shown in FIGS. 12, 13) are the modules in which the optical axes of the lenses (1, 2) and mirror pairs (8, 9 and 10,1 1) are placed in the same plane, which is the symmetry plane of the optical module (see FIG. 14). In such an implementation of the third embodiment of the device for viewing stereoscopic images video-displayed as right and left images, the modules (59, 60) are positioned on the main frame (61) so that the planes of the optical axes—the symmetry planes of the left and right modules—overlap and lie in a horizontal plane, with one module turned to the next at a 180° about the axis of its magnifying lens (see FIG. 14a). Similarly, for viewing stereoscopic images video-displayed as upper and lower images, the modules (59,60) are positioned on the main frame (61) so that the planes of the optical axes—the symmetry planes of the modules—are vertical, with one module turned to the next at a 180° about the axis of its magnifying lens (see FIG. 146). These vertical planes can be set as parallel, or may intersect in the centers of the upper and lower stereopair images.

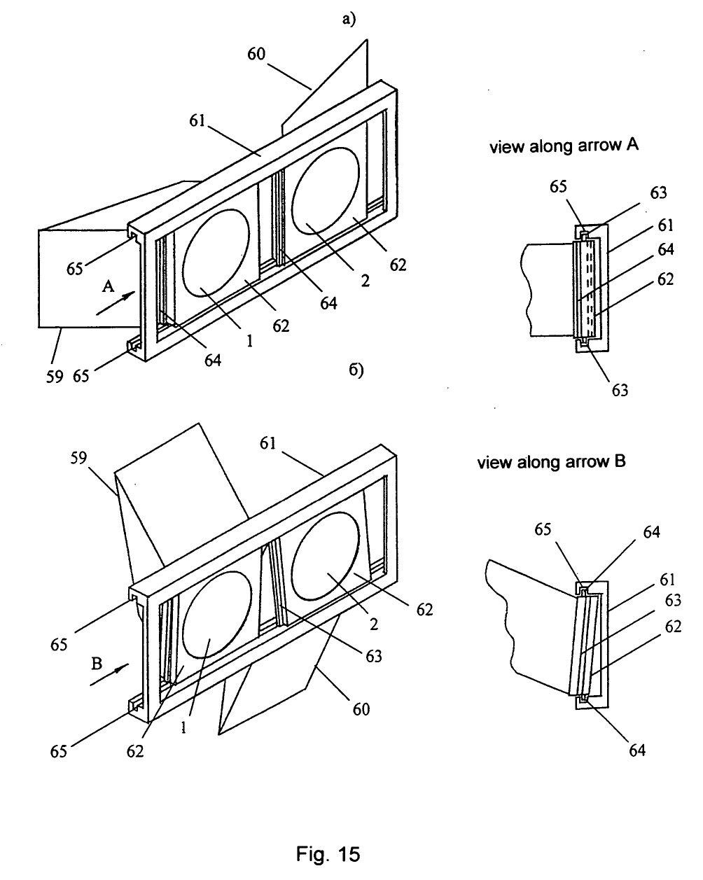

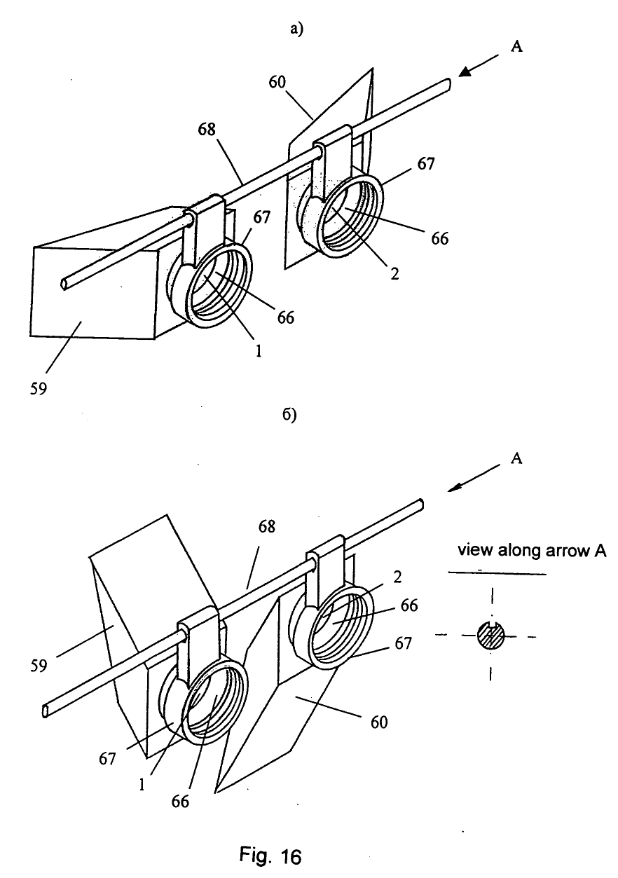

An important specific implementation of the third embodiment is a device distinctive in that the modules' (59, 60, see FIG. 15) side facing the viewer contains a square mounting frame (62) with correspondingly ribbed edges (63, 64) and a rectangular main frame with grooves (65) matching those edges, thus allowing for adjustment of the optical modules at a distance corresponding to the centers of the viewer's eyes. To allow viewing of stereoscopic images video-displayed as left and right images, the optical modules (59, 60) can be positioned on the main frame (61) when the edges (63) of the fixing frame (62) are inserted into the grooves (65) on the main frame (61); the edges are located symmetrically on different sides of the modules' symmetry plane. The planes of the optical axes—the modules' symmetry planes—are set in a horizontal plane (see FIG. 15a). The edges (63) of the modules (59, 60) are affixed to the main frame (61), with one module turned at a 180° to the other, thus ensuring the direction of their optical axes to the right end left stereopair image.

To allow viewing of stereoscopic images video-displayed as upper and lower images, the optical modules (59, 60) can be positioned on the main frame (61) when the edges (64) of the fixing frame (62) are inserted into the grooves (65) on the main frame (61); the edges are located on the sides of the fixing frame perpendicular to the modules' symmetry plane (see FIG. 156). The edges (64) of the modules are affixed to the main frame (61), with one module turned to the other at a 180° about the axis of its lens, providing for the direction of the modules' optical axes to the upper and lower stereopair images.

The edges (63) of the fixing frame (62) are made to lie in a plane parallel to the side of that frame facing the viewer (see FIG. 15a), and provide for the direction of the modules' optical axes to the centers of the left (6) and right (7) stereopair images (see FIG. 14a), with the video display screen, the distance between the screen and device, and average viewer eye parameters given. The edges (64) of the fixing frame (62) are displaced at a varying distance from the side facing the viewer (see arrow B in FIG. 156) so that when the modules (59, 60) are reset for viewing the upper and lower stereopair images, the modules' optical axes are directed at the horizontal symmetry lines of the upper (52) and lower (53) stereopair images (see FIG. 14b). The edges (64) can be made parallel to the back side of the frame (62), which will provide for the modules' optical axes being in parallel vertical planes. An alternative to this is the positioning of the edges (64) on the mounting frame (62) at a small angle to the back side of the frame, enabling the intersection of the module's optical axes' vertical planes in the centers of the upper and lower stereopair images.

Another particular implementation of the third embodiment of the invention with identical optical modules is a device (see FIG. 16) whose optical modules have, on the side facing the viewer, a circular fast (66), attached so as to ensure rotation about the magnifying lens's axis and affixed to another circular fast (67) mounted onto the main frame. The main frame is shaped as a molded rod (68), where rotation of the modules about the rod's axis is impossible. Rotation of the circular fast (66) inside the other fast (67) mounted onto the rod (68) enables the positioning of modules in a way that their optical axes lie in the plane of the eyes' optical axes, in case of viewing stereoscopic images video-displayed as left and right stereopair images (see FIG. 16a), or positioning in which the modules' axes lie in a plane perpendicular to the plane of the eyes' optical axes, in case of viewing stereoscopic images video-displayed as upper and lower stereopair images (see FIG. 16b). Displacing the modules (59, 60) along the rod's (68) axis allows the adjustment of the modules to the distance between the centers of the eyes.

Devices constructed in accordance to FIGS. 15 and 16 can include elements to adjust the modules' optical axes to the centers of the stereopair images through manipulating the distance between the device and the video display screen.

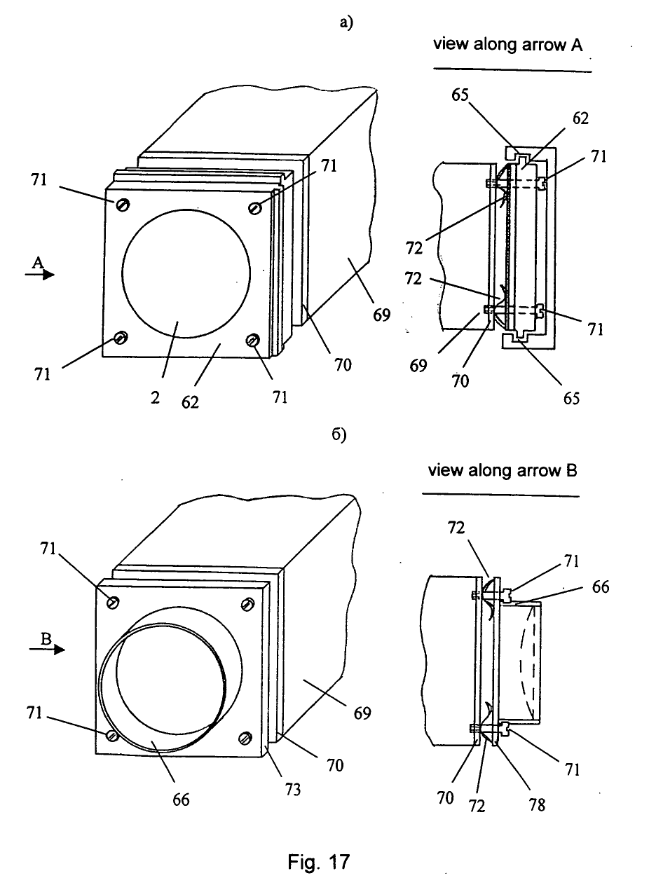

For this purpose, the optical modules (59, 60, see FIGS. 15, 16) consist of a hollow case (69, see FIG. 17) containing the mirror pairs, and a front flange (70). This front flange (70), when made according to FIG. 15, is joined to the fixing frame (72) supporting the lens (1 or 2) by tuning screws with threaded connection to the flange (70, see FIG. 17a). The screws (71) are positioned on the frame (62) to provide unhindered movement of the module mounting frame (62) on the main frame (61, see FIG. 15). Screwed on between the flange (70) and fixing frame (62) are flat springs (72). When the device is made as shown in FIG. 16, the front flange (70) is connected to the flange, facing the viewer (73) and supporting the circular fast (66), by tuning screws (71), which have a threaded connection to the front flange (70, see FIG. 17b). Flat springs (72) are installed between flanges (70 and 73). Rotation of the screws (71) allows the modules' optical axes to be adjusted horizontally and vertically.

In the particular implementations of the third embodiment (similarly to the first and second embodiments), which are characterized both by the features common for all implementations and the alternative features of the implementations described above, a the left (1) and right (2) magnifying lenses' diameter, D, equal 0.5 to 1.0 of the distance B between the lenses' optical axes (see FIG. 6a). The distance B is the average distance between the centers of the viewer's eyes (65 mm.) In an alternative implementation, the lenses' diameter D can be set as more than 1.0 but less than 1.3 of the distance B between the lenses' optical axes. In the latter case, the lenses are built with equal severed segments at the boundary between the lenses (see FIG. 6b). Large-diameter lenses allow the viewer to view the stereoscopic image without the eye fixating on the lenses' optical axes, thus preventing viewer fatigue.

An important implementation of the third embodiment of the invention is a device containing a unit that allows to affix it to the video display screen or to position it in front of the display screen, as described for the first embodiment (see FIGS. 8, 9).

While this invention has been particularly shown and described with references to preferred embodiments thereof, it will be understood by those skilled in the art that various changes in form and details may be made therein without departing from the scope of the invention encompassed by the appended claims.

What is claimed is:

1. A device for viewing a stereoscopic image, the device comprising:
a display providing the image in the form of a stereopair having a left image and a right image;
a left lens disposed between a left pair of mirrors and a left eye of a viewer, the left pair of mirrors having its reflective surfaces facing each other;
a right lens disposed between a right pair of mirrors and a right eye of the viewer, the right pair of mirrors having its reflective surfaces facing each other, both the left and the right pair of mirrors being disposed perpendicularly and symmetrically relative to a plane defined by optical axises of the right and the left lenses, and mirror symmetrically relative to a vertical symmetry plane of the left and the right lenses, the vertical symmetry plane being perpendicular relative to the plane defined by the optical axises;
wherein the left image of the stereopair is projected to a left mirror of the left pair, then to a right mirror of the left pair, then to the left eye via the left lens, and
wherein the right image of the stereopair is projected to a right mirror of the right pair, then to a left mirror of the right pair, and then to the right eye via the right lens; and
wherein the stereoscopic image is formed by converging the left and the right eyes at a convergence angle defined by a virtual distance between an imaginary image and the left and the right eyes.

2. The device as in claim 1, wherein the right and the left lenses and the right and the left pairs of mirrors are made as similar optical modules in which the positions of the lenses and the mirrors are fixed, and wherein the modules are mounted on a frame and the optical axises of the lenses form a 180° angle relative to each other.

3. The device of claim 2, wherein the modules are horizontally displaceable along the frame to adjust to a distance between the eyes of the viewer.

4. The device of claim 1, wherein the diameter of the lenses ranges from 0.5 to 1.0 times the distance between the optical axises of the lenses.

5. The device of claim 1, wherein the diameter of the lenses is greater than the distance between the optical axises of the lenses, but smaller than 1.3 times the distance between the optical axises of the lenses, and wherein the lenses are truncated at a boundary between them.

6. The device of claim 1, wherein each of the mirrors is made in the form of a trapezoid having the dimensions such that the viewer perceives images within the boundaries corresponding to those of the left and right images of the stereopair, and excluding images outside of such boundaries.

7. A device for viewing a stereoscopic image, the device comprising:
a display providing the image in the form of a stereopair comprised of two images disposed one above the other, one of images to be viewed with a left eye of a viewer and the other image to be viewed with the right eye of the viewer;
a left lens disposed between a left pair of mirrors and a left eye of the viewer, the left pair of mirrors having its reflective surfaces facing each other;
a right lens disposed between a right pair of mirrors and a right eye of the viewer, the right pair of mirrors having its reflective surfaces facing each other,
wherein the optical axis of an upper image is directed via one of the pair of mirrors into one of the eyes of a viewer via a corresponding lens and wherein the optical axis of a lower image is directed via the other pair of mirrors into the other eye of the viewer via the other lens; and
wherein the stereoscopic image is formed by converging the left and the right eyes at a convergence angle corresponding to a virtual distance between an imaginary image and the left and the right eyes.

8. The device of claim 7, wherein the optical axises passing from the upper and lower images through the corresponding lenses and the pairs of mirrors are disposed in vertical planes, and wherein the pairs of mirrors are disposed perpendicular to the vertical planes at the angles directing one optical axis to the left eye and the other optical axis to the right eye of the viewer.

9. The device of claim 7, wherein the lenses and the right and the pairs of mirrors are made as similar optical modules mounted on a frame and the optical axises of the lenses form a 180° angle relative to each other, and wherein the modules are disposed at a 90° angle relative to the plane defined by the optical axises of the lenses.

10. The device of claim 9, wherein the modules are connected in such a way that an angle between the modules can be altered.

11. The device of claim 7, wherein the diameter of the lenses ranges from 0.5 to 1.0 times the distance between the optical axises of the lenses.

12. The device of claim 7, wherein the diameter of the lenses is greater than the distance between the optical axises of the lenses, but smaller than 1.3 times the distance between the optical axises of the lenses, and wherein the lenses are truncated at a boundary between them.

13. The device of claim 7, wherein each of the mirrors is made in the form of a trapezoid having the dimensions such that the viewer perceives images within the boundaries corresponding to those of the left and right images of the stereopair, and excluding images outside of such boundaries.

14. The device of claim 7, wherein each of the mirrors is made in the form of a trapezoid having the dimensions such that the viewer perceives images within the boundaries corresponding to those of the left and right images of the stereopair, and excluding images outside of such boundaries.

15. A device for viewing a stereoscopic image, the device comprising:
a display providing the image in the form of a stereopair having a first image and a second image;
a left lens disposed between a left pair of mirrors and a left eye of a viewer, the left pair of mirrors having its reflective surfaces facing each other;
a right lens disposed between a right pair of mirrors and a right eye of the viewer, the right pair of mirrors having its reflective surfaces facing each other,
wherein the left lens and the left pair of mirrors are made in the form of a first optical module similar to a second optical module comprised of the right lens and the right pair of mirrors, both the first and the second optical modules being disposed on a frame and directing a first optical axis of the first image and a second optical axis of the second image into the left and the right eyes of a viewer, wherein the first image and the second image can be the left and the right images or the upper and the lower images.

16. The device of claim 15, wherein the diameter of the lenses ranges from 0.5 to 1.0 times the distance between the optical axises of the lenses.

17. The device of claim 15, wherein the diameter of the lenses is greater than the distance between the optical axises of the lenses, but smaller than 1.3 times the distance between the optical axises of the lenses, and wherein the lenses are truncated at a boundary between them.

18. The device of claim 1, wherein the frame is in the form of a box with parallel upper and lower panels in which frame the right and the left pairs of mirrors are mounted perpendicularly to the panels, and wherein the lenses are mounted on a side of the frame facing the viewer.

19. The device of claim 18, wherein the lenses are displaceable to adjust to the distance between the viewer's eyes.
